(19) United States
(12) Patent Application Publication
(10) Pub. No.: US 2026/0285405 A1
(43) Pub. Date: Sep. 24, 2026

(54) UPPER LOAD BEAM BENDING SCRIPT TO OPTIMIZE GLANCING MODE PERFORMANCE IN IIHS SMALL-OVERLAP CRASH MODE

(71) Applicant: FCA US LLC, Auburn Hills, MI (US)

(72) Inventors: Santosh PETHE, Auburn Hills, MI (US); Eric J. STAHMER, Auburn Hills, MI (US); Kedar V. PANDAY, Auburn Hills, MI (US); Scott A. MCGUIRE, Auburn Hills, MI (US)

(21) Appl. No.: 19/086,222

(22) Filed: Mar. 21, 2025

(51) Int. Cl. B62D 21/15

(52) U.S. Cl. CPC B62D 21/155

(57) ABSTRACT

A vehicle front loading beam has a load beam portion that extends between a grille and a cab of the vehicle. The load beam portion is positioned adjacent a front fender of the vehicle. A load beam outer initiator is coupled with the load beam, The load beam initiator includes a first member to initiate bending of the loading beam when a desired force is exerted. A cowl initiator is coupled with the load beam outer initiator. The cowl initiator is positioned adjacent the cab. The cowl initiator includes a second member to initiate bending of the cowl initiator when a desired force is exerted. The loading beam curves inward toward an engine compartment upon exertion of the force to reduce impact loading on a hinge pillar.

The present disclosure relates to automobiles and, more particularly, to the integrity of the front load beams.

### BACKGROUND

This section provides background information related to the present disclosure which is not necessarily prior art.

In automotive vehicles, various types of load beams are utilized to provide vehicle integrity. In the front end of the vehicle, load beams are present for carrying loads. Specifically, the load beams, while providing a frame for external body parts, also enhance the strength of the vehicle during an impact. Thus, the load beams are designed to reduce the load that may be applied onto the vehicle cab. Load beams that are positioned in the front of the vehicle along the vehicles fenders and under carnage reduce impact on the vehicle in the hinge pillar area to ensure stability in a glancing blow mode. When this occurs, the load beams crush toward the hinge pillar and toward the occupant area. It is desirable to reduce the impact at the hinge pillar to eliminating a breach that would enable access into the passenger compartment.

Accordingly, the present disclosure provides a load beam that reduces if not eliminates passenger compartment breach during a glancing blow mode. The present disclosure enables deformation of the load beam toward an engine compartment of the vehicle. This bending reduces impact load on the hinge pillar ensuring stability.

### SUMMARY

This section provides a general summary of the disclosure, and is not a comprehensive disclosure of its full scope or all of its features.

According to a first aspect of the disclosure, a vehicle front loading beam comprises a load beam that extends between a grille and cab or passenger compartment of the vehicle. The load beam is positioned adjacent a front fender of the vehicle. A load beam outer initiator is coupled with the load beam. The load beam outer initiator includes a first member to initiate bending of the load beam when a desired force is exerted. A cowl initiator is coupled with the load beam outer initiator. The cowl initiator is positioned adjacent the cab or passenger compartment. The cowl initiator includes a second member to initiate bending of the cowl initiator when a desired force is exerted. The load beam curves inward upon exertion of the force to reduce impact load on a hinge pillar. The first member is a discontinuity in the outer initiator such as an aperture, rib, crease or bend that initiates bending of the load beam outer initiator when a desired force is applied. The second member is a discontinuity in the cowl initiator such as an aperture, a rib, a crease or bend to initiate bending of the cowl initiator. The load beam outer and cowl initiator are positioned adjacent the cab end of the load beam. The load beam follows a bending script upon exertion of the force.

According to a second aspect of the disclosure, an electric vehicle with a front loading beam comprises a front grille between a pair of front fenders that extend towards a cab or a passenger compartment. The loading beam is adjacent the fenders extending between the grille and cab. The loading beam includes a load beam that extends between the grille and cab or passenger compartment of the vehicle. The load beam is positioned adjacent a front fender of the vehicle. A load beam outer initiator is coupled with the load beam. The load beam outer initiator includes a first member to initiate bending of the load beam when a desired force is exerted. A cowl initiator is coupled with the load beam outer initiator. The cowl initiator is positioned adjacent the cab or passenger compartment. The cowl initiator includes a second member to initiate bending of the cowl initiator when a desired force is exerted. The load beam curves inward upon exertion of the force to reduce impact load on a hinge pillar. The first member is a discontinuity in the outer initiator such as an aperture, rib, crease or bend that initiates bending of the load beam outer initiator when a desired force is applied. The second member is a discontinuity in the cowl initiator such as an aperture, a rib, a crease or bend to initiate bending of the cowl initiator. The load beam outer and cowl initiator are positioned adjacent the cab end of the load beam. The load beam follows a bending script upon exertion of the force.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective schematic view of the front of an example vehicle according to a principle of the present disclosure;

FIG. 2 is an isometric perspective view of a load beam outer initiator panel according to a principle of the present disclosure;

FIG. 3 is a perspective view of a cowl initiator panel according to a principle of the present disclosure; and

FIG. 4 is a perspective view of the front of the example vehicle of FIG. 1 in a crumpled position.

Corresponding reference numerals indicate corresponding parts throughout the several views of the drawings.

### DETAILED DESCRIPTION

Example embodiments will now be described more fully with reference to the accompanying drawings.

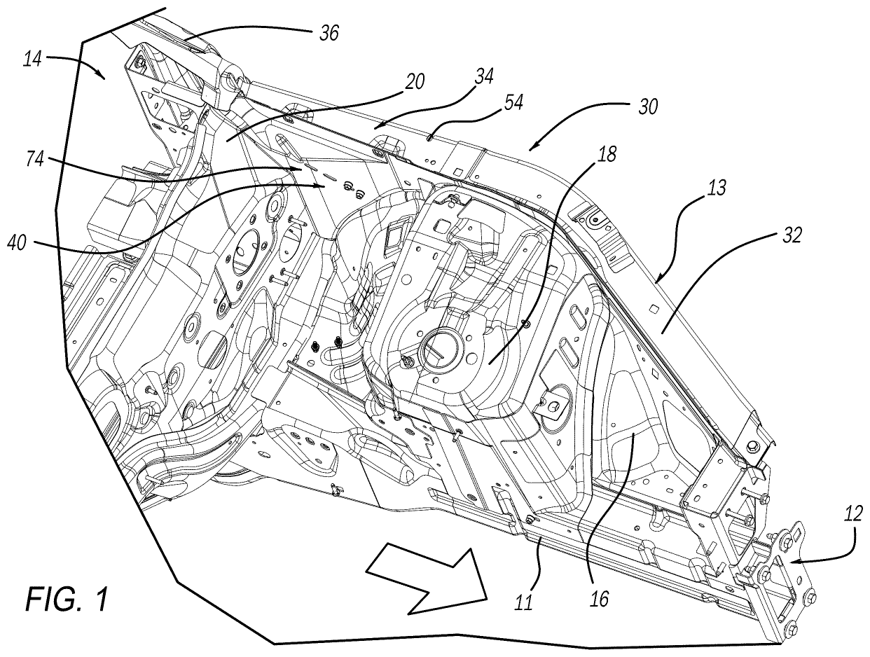

Turning to the figures, FIG. 1 illustrates a partial front end of a vehicle 10. The vehicle 10 includes a pair of longitudinal frame members 11 (of which one is shown in FIG. 1) having an end portion 12 to which a front grille (not shown) may be attached, a pair of fenders 13 (of which one is shown in FIG. 1) and an occupant compartment or cab 14. A wheel well housing 16 includes a shock absorber tower 18 along a path to the front wall 20. A load beam 30 of the fender 13 extends from a position proximate end portion 12 to the cab 14. While only a single load beam 30 is illustrate din FIG. 1, it should be understood that a load beam 30 is positioned on each side of the vehicle 10.

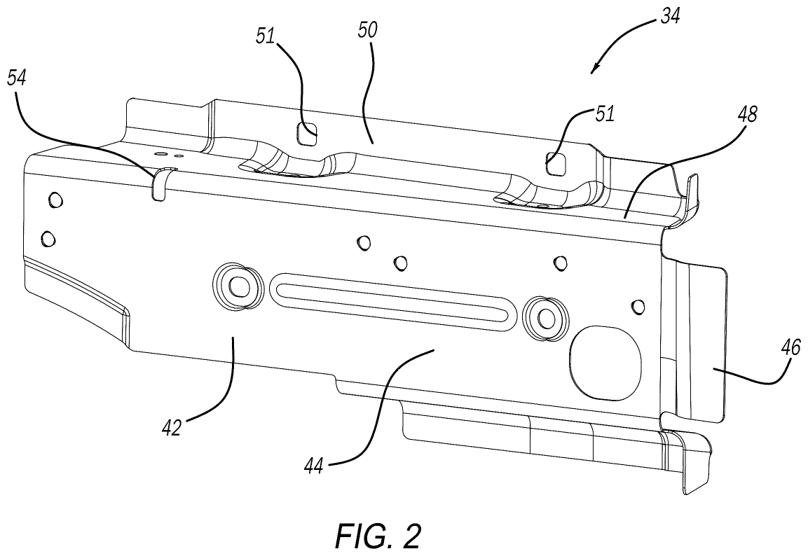

The load beam 30 includes a beam portion 32, and a load beam outer initiator 34 is secured to an outer surface of the load beam portion 32 that extends to a hinge pillar 36. A cowl initiator 40 is coupled with the load beam outer initiator 34, and is located on an inner surface of the load beam portion 32. As best shown in FIG. 2, the load beam outer initiator 34 includes a body 42 having an L-shaped configuration. A long leg 44 of body 42 includes a secondary tab 46 that extends toward the beam portion 32. A short leg 48 unitary with the long leg 44 includes a flange 50 having apertures 51 configured for receipt of a fastener (not shown) for securing body 42 to beam portion 32.

The body 42 includes a first initiator 54 to assist in enabling bending of the load beam 30 in a desired manner upon exertion of an external force to either end portion 32 or fender 13. The first initiator 54 generally includes an aperture (as illustrated), but may also be in the form of a rib, crease, bend or the like to initiate the bending of the load beam 30 in the desired direction upon exertion of a force. The first initiator 54 is generally positioned toward the cab divider wall 20 and is at the junction of the L between the long and short legs 44, 48. The load beam outer initiator 34 may be formed of a rigid metal material such as steel, and is generally welded with the load beam portion 32 as well as with the underbody of the vehicle 10.

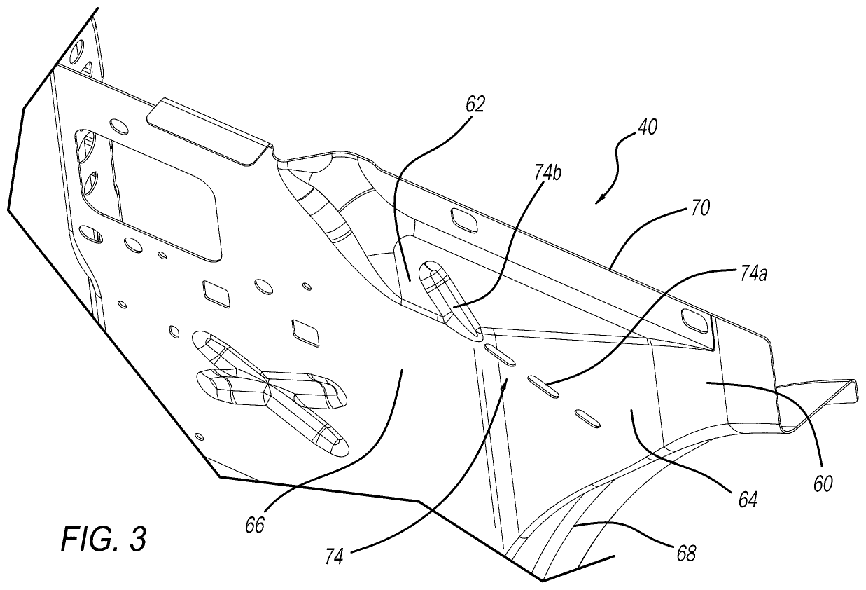

Now referring to FIG. 3, the cowl initiator 40 includes a body 60 with a top 62, a front 64, and side wall 66. These walls 62, 64, 66 provide an overall hollow box shape for the cowl initiator 40. A flange 68 extends from the front 64 and side 66 walls to enable securement with the wheel well 16. A second flange 70 enables securement of the cowl initiator 40 with the load beam outer initiator 34 as well as with the beam portion 32. The cowl initiator 34 includes a second load initiator 74 that extends from the top wall 62 to the front wall 64 adjacent the side wall 66. The second load initiator 74 is a discontinuity and may include at least one of an aperture, a plurality of apertures (as shown at 74a), at least one rib (as shown at 74b), a crease, a bend or the like to initiate bending of the cowl initiator 40 upon an exertion of force.

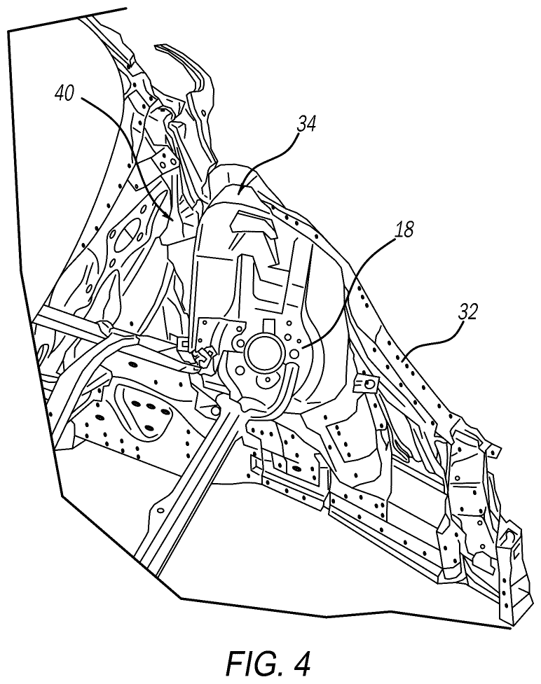

When installed in the vehicle 10, the load beam 30 extends from a position proximate the end portion 12 to the vehicle cab 14. The beam 30 is secured with the underbody structure as well as with outer load beams. The load beam outer initiator 32 and the cowl initiator 34 are adjacent the front of the cab 14 adjacent the junction of the front wall 20 and fender 13, at the end of the beam 30. The cowl initiator 34 extends to the hinge pillar 36 and is welded integrally with the various parts to enhance the load beam 30 bending at the front of the vehicle 10 against impact. When a glancing blow mode is applied to the vehicle 10, the load beam 30 bends inward toward the engine compartment (FIG. 4) to reduce impact loading on the hinge pillar 36 to ensure stability. The cowl initiator 34 and load beam outer initiator 32 are attached with the beam portions 32 such that they enable the load beam 30 to curve toward the engine compartment. Accordingly, as the load beam 30 bends, it upholds its integrity ensuring the stability of the hinge pillar 36 area and minimizes any breach that may occur to the passenger compartment area 14. Thus, the present load beam 30 ensures the hinge pillar 36 integrity under high loads.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A vehicle front loading beam comprising:
a load beam portion extending between a grille and a cab of the vehicle, the load beam portion to be positioned adjacent a front fender of the vehicle;
a load beam outer initiator coupled with the load beam portion, the load beam initiator including a first member for initiating bending of the load beam when a desired force is exerted;
a cowl initiator coupled with the load beam outer initiator, the cowl initiator positioned adjacent the cab, the cowl initiator including a second member for initiating bending of the cowl initiator when a desired force is exerted; and
the load beam curving inward upon exertion of the force to reduce impact load on a hinge pillar.

2. The vehicle front loading beam of claim 1, wherein the first member is a discontinuity in the outer initiator.

3. The vehicle front loading beam of claim 2, wherein the discontinuity is an aperture, a rib, a crease or a bend for initiating bending of the load beam outer initiator.

4. The vehicle front loading beam of claim 1, wherein the second member is a discontinuity in the cowl initiator.

5. The vehicle front loading beam of claim 4, wherein the discontinuity is on an aperture, a rib, a crease or a bend for initiating bending of the cowl initiator.

6. The vehicle front loading beam of claim 1, wherein the load beam outer and cowl initiators are positioned adjacent to the cab at an end of the load beam.

7. The vehicle front loading beam of claim 1, wherein the load beam follows a bending script upon exertion of the force.

8. An electric vehicle with a front loading beam comprising:
a front grille between a pair of front fenders that extend toward a cab and a loading beam adjacent each fender extending between the grille and the cab, the loading beams including:
a load beam portion extending between a grille and a cab of the vehicle, the load beam portion to be positioned adjacent a front fender of the vehicle;
a load beam outer initiator coupled with the load beam portion, the load beam initiator including a first member for initiating bending of the load beam when a desired force is exerted;
a cowl initiator coupled with the load beam outer initiator, the cowl initiator positioned adjacent the cab, the cowl initiator including a second member for initiating bending of the cowl initiator when a desired force is exerted; and
the load beam curving inward upon exertion of the force to reduce impact load on a hinge pillar.

9. The electric vehicle with the front loading beam of claim 8, wherein the first member is a discontinuity in the outer initiator.

10. The electric vehicle with the front loading beam of claim 9, wherein the discontinuity is an aperture, a rib, a crease or a bend for initiating bending of the load beam outer initiator.

11. The electric vehicle with the front loading beam of claim 8, wherein the second member is a discontinuity in the cowl initiator.

12. The electric vehicle with the front loading beam of claim 11, wherein the discontinuity is on an aperture, a rib, a crease or a bend for initiating bending of the cowl initiator.

13. The electric vehicle with the front loading beam of claim 8, wherein the load beam outer and cowl initiators are positioned adjacent to the cab at an end of the load beam.

14. The electric vehicle with the front loading beam of claim 8, wherein the load beam follows a bending script upon exertion of the force.
